(19) United States
(12) Patent Application Publication
(10) Pub. No.: US 2003/0063311 A1
(43) Pub. Date: Apr. 3, 2003

(54) Method and apparatus identifying printing supplies

(76) Inventors: Marc L. Covitt, Encinitas, CA (US); Mark McGarry, San Diego, CA (US)

Correspondence Address: HEWLETT-PACKARD COMPANY, Intellectual Property Administration, P.O. Box 272400, Fort Collins, CO, 80527-2400, US

(21) Appl. No.: 10/055,325

(22) Filed: Jan. 22, 2002

Related U.S. Application Data
(60) Provisional application No. 60/327,112, filed on Oct. 3, 2001.

(51) Int. Cl. B41F 1/00; G06F 15/00

(52) U.S. Cl. 358/1.15; 358/1.14

(57) ABSTRACT

The present disclosure relates to a replaceable printing component for use in a selected printing system. The replaceable printing component includes an electrical storage device configured for storing a data value and an identifier value. The identifier value is derived by encrypting the data value using an encryption process. Upon installation of the replaceable printing component into the selected printing system the selected printing system processes the data value using the encryption process to obtain an encrypted value. The encrypted value is identical to the identifier value if the replaceable printing component is a verified replaceable printing component.

### CROSS REFERENCE TO RELATED APPLICATIONS

This application is a continuation-in-part of provisional application filed on Oct. 3, 2001 entitled METHOD AND APPARATUS FOR THE IDENTIFICATION OF PRINTING SUPPLIES, attorney docket 100110368-1, application No. 60/327112.

### BACKGROUND OF THE INVENTION

The present invention relates to printing systems that make use of replaceable printing components. More particularly, the present invention relates to a replaceable ink container that includes a memory for storing printer parameter information for use by the printing system.

Printing systems such as inkjet printers frequently make use of an inkjet printhead mounted to a carriage that is moved back and fourth across a print media, such as paper. As the printhead is moved across the print media, a control system activates the printhead to deposit or eject, ink droplets onto the print media to form images and characters.

One type of inkjet printer previously used makes use of a replaceable ink cartridge. The ink cartridge includes a printhead and an ink reservoir that are contained within cartridge housing. When the ink reservoir is depleted of ink or a different type of ink is required for a particular print media the entire ink cartridge is replaced. Another type of inkjet printer makes use of an inkjet printhead and an ink supply that can each be separately replaced. For this type of inkjet printer the ink supply is spaced from the printhead. The printhead is mounted to the carriage and ink is provided to the printhead by way of a flexible fluid interconnect extending between the ink supply and the printhead. For this type of arrangement, the ink supply container can be replaced without replacing the printhead. The printhead is then replaced at the printhead end of life.

It is frequently desirable to alter printer parameters concurrently with the replacement of printer consumables as discussed in issued U.S. Pat. No. 5,699,091 entitled “Replaceable Part with Integral Memory for Usage, Calibration and Other Data” assigned to the assignee of the present invention. There are several reasons for updating printer parameters. One reason for updating printer parameters is to incorporate engineering improvements into the printer. Another reason for updating printer parameters is to optimize the printer for the particular consumable to be installed in the printer.

One method for altering printer parameters is discussed in the '091 patent is the use of a memory that is associated with the replaceable ink container. For this embodiment, insertion of the replacement ink container establishes an electrical connection between the printer and the memory associated with the ink container. This electrical connection allows for the exchange of information between the printer and the memory. Updating or altering printer parameters at the same time as the ink container is replaced ensures that the printer is optimized for the particular ink used. In addition, updating printing parameters with the replacement of the ink container ensures that the printer makes use of the latest printer parameters.

Frequently, more than one type of printer is configured to use the same type of replaceable printing component. In order to provide customer benefit it may be necessary to customize the replaceable printing component so that a particular printer will accept only the customized replaceable consumable. For example, different printers produced by different Original Equipment Manufacturers (OEM's) may be each configured to use the same replaceable ink container. To provide maximum customer value it may be necessary for an OEM to customized supplies for a particular printer type. In order to ensure customer value it may be necessary to prevent the particular printer type from using replaceable ink containers other than those customized.

### SUMMARY OF THE INVENTION

The exemplary embodiment of the method and apparatus of the present invention is a replaceable printing component for use in a selected printing system. The replaceable printing component includes an electrical storage device configured for storing a data value and an identifier value. The identifier value is derived by encrypting the data value using an encryption process. Upon installation of the replaceable printing component into the selected printing system the selected printing system processes the data value using the encryption process to obtain an encrypted value. The encrypted value is identical to the identifier value if the replaceable printing component is a verified replaceable printing component.

### BRIEF DESCRIPTION OF THE DRAWINGS

FIGS. 1A and 1B depict a schematic diagram of an exemplary embodiment representing an inkjet printing system that includes replaceable ink container having a memory thereon for transferring information from the ink container to a printer control portion.

FIG. 2 depicts a block diagram representing the inkjet printing system shown in FIG. 1.

FIG. 3 depicts a block diagram representing one embodiment of the electrical interface between the printer control portion and the ink container memory.

FIG. 4 depicts a block diagram representing an alternative embodiment of the electrical interface between the printer control portion and the ink container memory.

FIG. 5 is a simplified block diagram of a replaceable ink container that is an exemplary embodiment of the present invention.

FIG. 6 is a simplified block diagram of a memory programming device according to an exemplary embodiment of the present invention.

FIG. 7 is a flow diagram of a method for generating encrypted data and storing the encrypted data in the memory device of the exemplary embodiment.

FIG. 8 is a simplified block diagram of a printer according to an exemplary embodiment of the present invention.

FIG. 9 is a flow diagram of a process for verifying the identification of the replaceable ink container of the exemplary embodiment of the present invention.

### DETAILED DESCRIPTION OF THE EXEMPLARY EMBODIMENT

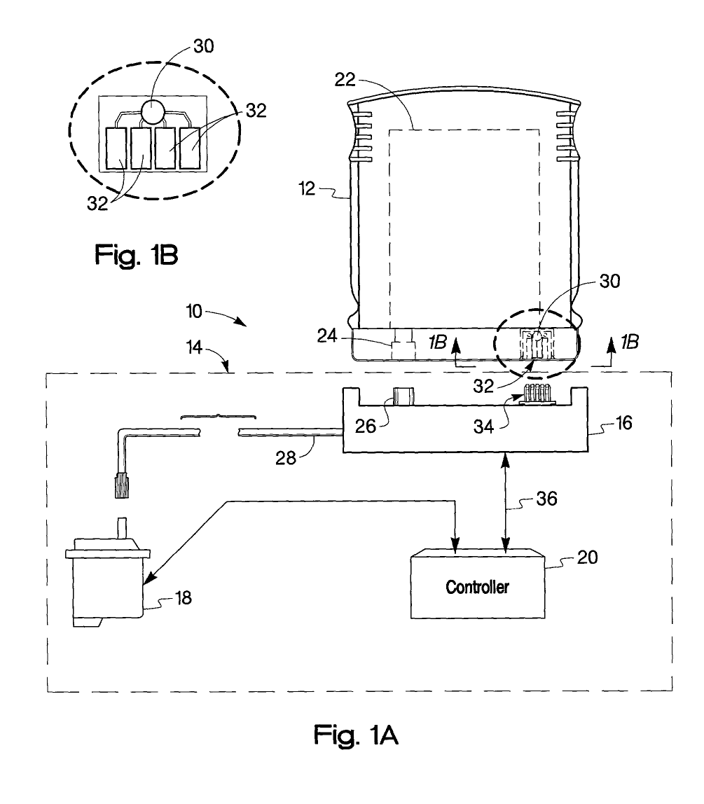

FIGS. 1A and 1B are representations an inkjet printing system 10 of the exemplary embodiment of the present invention. The inkjet printing system 10 includes an ink container or cartridge 12 and a printer portion 14. The printer portion 14 includes an ink container receiving station or a receptacle 16, a printhead 18 and a controller 20. With the ink container 12 properly inserted into the ink container receiving station 16, an electrical and a fluidic coupling is established between the ink container 12 and the printer portion 14. The fluidic coupling allows ink stored within the ink container 12 to be provided to the printhead 18. The electrical coupling allows information to be passed between the ink container 12 and the printer portion 14 to ensure the operation of printer portion 14 is compatible with the ink contained in the ink cartridge 12 to achieve optimal print quality.

In addition to transferring information between the printer portion 14 and the ink container 12, the controller 20 controls the relative movement of the printhead 18 and the print media (not shown). The controller 20 also selectively activates the printhead 18 to deposit ink on the print media. By selectively activating the printhead 18, as the printhead 18 and print media are moved relative to each other, images and text are formed on print media.

The ink container 12 includes a reservoir 22 for storing ink therein. A fluid outlet 24 is provided that is in fluid communication with the fluid reservoir 22. The fluid outlet 24 is configured for connection to a complimentary fluid inlet 26 associated with the ink container receiving station 16. A fluid conduit 28 is connected between the fluid inlet 26 and the printhead 18. This fluid conduit 28 may be a continuous fluid conduit in the case of a flexible conduit or an intermittent fluid conduit in the case where the printhead is positioned at a refilling station for replenishing ink. In either case, with the ink container 12 properly inserted into the ink container receiving station 16, fluid communication is established between the ink container 12 and the printhead 18.

The ink container 12 also includes an information storage device or memory 30 for storing information related to the ink container 12. A plurality of electrical contacts 32 are provided that are each electrically connected to the electrical storage device 30. With the ink container 12 properly inserted into the ink container receiving station 16, each of the plurality of electrical contacts 32 engage each of a plurality of electrical contacts 34 associated with the ink container receiving station 16. Each of the plurality of electrical contacts 34 is electrically connected to the controller 20 by a plurality of electrical conductors 36. With proper insertion of the ink container 12 into the ink container receiving station 16, the memory 30 associated with the ink container 12 is electrically connected to the controller 20 allowing information to be transferred between the ink container 12 and the printer portion 14.

The memory 30 associated with the ink container 12 is shown having 4 electrical contacts or terminals 34, although the number of terminals can be even fewer than four. As discussed later with respect to FIG. 4 the memory 30 may have only two electrical contacts 32 associated therewith. It is generally preferred that the number of electrical contacts 32 be kept relatively small in order to increase the reliability of the connection between the ink container 12 and the printer portion 14.

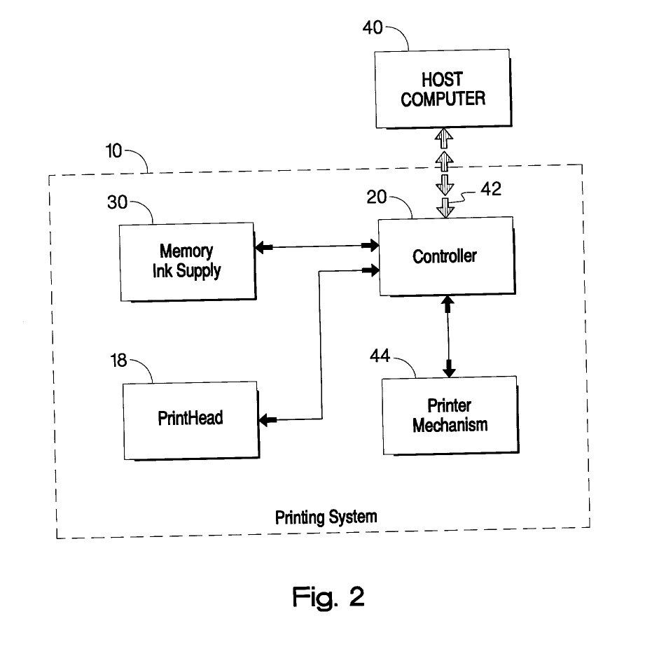

FIG. 2 is a block diagram representing the inkjet printing system 10 of the exemplary embodiment shown connected to an information source or host computer 40. The host computer 40 is a conventional computer, such as a workstation, server or personal computer, to name a few, that provides image information to the controller 20 by way of a link 42. The link 42 is a conventional printer interface such as an electrical link or an infrared link for allowing information transfer between the host computer 40 and the printing system 10.

The controller 20 controls a printer mechanism 44 and the printhead 18 to selectively eject ink droplets as the printhead and print media are moved relative to each other. Various parameters for controlling operation of the printing system 10 are provided by the host computer 40 or are provided by the memory 30 associated with the ink supply 12. Printer parameter information provided by the host computer 40 is typically resident in printer control software that is typically referred to as the “print driver”. One problem with providing printer parameter information from the print driver that is resident in the host computer 40 is that the print driver software is typically not updated often. An important aspect of the present invention is the use of a memory 30 on the ink container 12 to provide printer parameter information to the controller 20. Because the ink container 12 is regularly replaced when the ink is exhausted, printer parameters can be updated regularly to ensure the highest print quality. In addition, printer parameters, which are unique to the particular ink contained in the ink container 12, can be updated using the memory 30 automatically without requiring the user to configure the printer or print driver for the particular ink container 12 installed. By automatically updating printer parameters the printing system 10 provides consistent output quality as well as improved ease-of-use.

Among the parameters stored in the memory 30 on ink container 12 may be the following: actual count of ink drops emitted from the printhead 18; date code of the ink supply; date code of initial insertion of the ink container 12; system coefficients; ink type/color; ink container size; print mode; temperature data and heater resistor parameters; age of the ink container; drop count for the printhead 18; a pumping algorithm for the case where the ink container 12 is pressurized for higher ink flow rates between the ink container 12 and printer portion 14; printer serial number; cartridge usage information; to name a few.

Upon insertion of the ink container 12 into the printer portion 14 the controller 20 reads the parameter information from the memory 30 for controlling various printing functions within the printing system 10. For example, the controller 20 computes an estimate of remaining ink in the ink container 12 and compares the estimate against prerecorded supply thresholds. If the ink remaining in the ink container 12 is found to be less than 25% of full capacity, a message is provided to the user indicating the remaining ink level. Further, when a substantial portion of the remaining 25% of the ink is consumed, the controller 20 can disable the inkjet printing system 10 to prevent dry firing of the printhead, which can damage to the printhead 18.

Another example of how parameter information stored in the memory 30 can be used by the controller 20 is to verify that proper ink type and color is installed properly in the printing system 10. In addition, the controller 20 can provide a notice to the user when the ink within the ink container 12 is beyond its shelf-life so that the ink container 12 can be replaced ensuring maximum print quality.

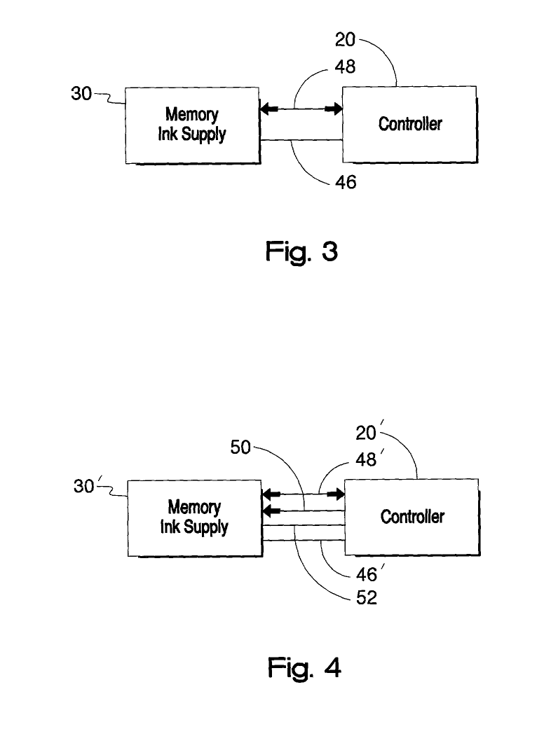

FIG. 3 shows greater detail of the electrical connection between the controller 20 and the memory 30 associated with the ink container 12 in the exemplary embodiment. For this exemplary embodiment the memory 30 is a memory that is capable of performing information transfers with the controller 20 entirely over a single wire communication line 48 and a common ground reference or ground return conductor 46. Information transfers from the memory 30 (memory read operations) to the controller 20 and information transfers from the controller 20 to the memory 30 (memory write operations) are performed entirely over a single wire communication line 48 and the ground reference 46.

The transfer of information to and from the memory 30 over the single wire communication line 48 and ground reference 46 is accomplished using a one-wire protocol. Data address and control information is transferred between the controller 20 and the memory 30 in a serial fashion using this one-wire protocol. In one embodiment, the memory 30 is a 1K Bit read/write Electrically Programmable Read Only Memory (EPROM) such as the Dallas Semiconductor part number DS 1982, manufactured by the Dallas Semiconductor Corporation.

For the embodiment shown in FIG. 3 power is provided to the memory 30 via the single-wire communication line 48. For this embodiment, the memory 30 derives its power from the presence of a high signal on the one wire communication line 48. An internal capacitor that is integral with the memory 30 stores energy when the single wire communication line 48 is high such that the memory 30 can operate off the stored energy when the signal on the single wire communication line 48 is low. Therefore, only a single electrical terminal or contact 32 and ground terminal or contact 32 is required for the memory 30 to provide power, control, data and address information to the memory 30.

The use of a serial, bidirectional, single-wire communication line 48 for transferring information between the controller 20 and the memory 30 provides for a highly reliable electrical interconnect between the memory 30 and the controller 20. In addition, power and control information are also provided on the one-wire communication line 48 even further reducing the number of electrical interconnects required between the memory 30 and the controller 20 further increasing reliability as well as reducing manufacturing costs.

FIG. 4 represents an alternative embodiment of the memory 30 and electrical interconnection between the memory 30 and the controller 20 shown in FIG. 3. Similar numbering will be used in FIG. 4 to represent structures similar to those shown in the embodiment shown in FIG. 3. The embodiment of FIG. 4 is similar to the embodiment of FIG. 3 except that instead of providing power and all control information to the memory 30 via the single-wire communication line 48 as shown in FIG. 3 the embodiment of FIG. 4 makes use of a memory 30′ that has a separate electrical conductor for providing a power and a clock signal. One example of a commercially available part similar to the memory 30′ is a memory sold as part number 24C00 128 bit Serial EEPROM manufactured by Microchip Technology Inc.

Data is transferred between memory 30′ and the controller 20′ via a serial, bidirectional, single-wire communication line 48′ and a ground or signal return 46′ in a manner similar to the single-wire communication line 48 shown in FIG. 3. During memory read operations address information is provided in a serial manner to the memory 30′ over the single-wire communication line 48′ by the controller 20′. Data corresponding to the address information is provided serially to the controller 20′ over the single-wire communication line 48′ by the memory 30′. During memory write operations data and address information is provided to the memory 30′ in a serial fashion over the single-wire communication line 48′. An interface protocol, similar to the one-wire communication protocol, is use to ensure orderly transfer of this address, data and command information.

A serial clock line 50 is provided to the memory 30′ as an additional control line for providing control signals from the controller 20′ to the memory 30′. The clock line 50 ensures that data is properly transferred on the single wire communication line 48′. For example, the memory 30′ samples data on a transition of the clock line from low to high. Therefore, care must be taken to ensure the data is stable prior to the low to high transition of the clock line 50.

A separate power electrical conductor 52 is provided to the memory 30′ in the embodiment shown in FIG. 4 instead of providing power on the one-wire communication line 48, as shown in the embodiment of FIG. 3.

The use of a serial bidirectional communication line for transferring data between the controller 20 and the memory 30,30′associated with the ink container 12 reduces the number of electrical connections required between the memory 30, 30′ and the controller 20,20′, respectively. For example, the embodiment shown in FIG. 3 requires only two electrical contacts or terminals 32 associated with the ink container 12 for transferring information between the ink container 12 and the printer portion 14 (see FIG. 1). One of the terminals 32 is connected to the single-wire communication wire 48 and the other terminal connected to the ground wire 46.

The embodiment shown in FIG. 4 requires only four electrical contacts or terminals 32 associated with the ink container 12 as shown in FIG. 1B. The use of a small number of electrical connections between the memory 30, 30′ and controller 20 enhances the reliability of this electrical connection as well as reducing the manufacturing costs associated with the printing system.

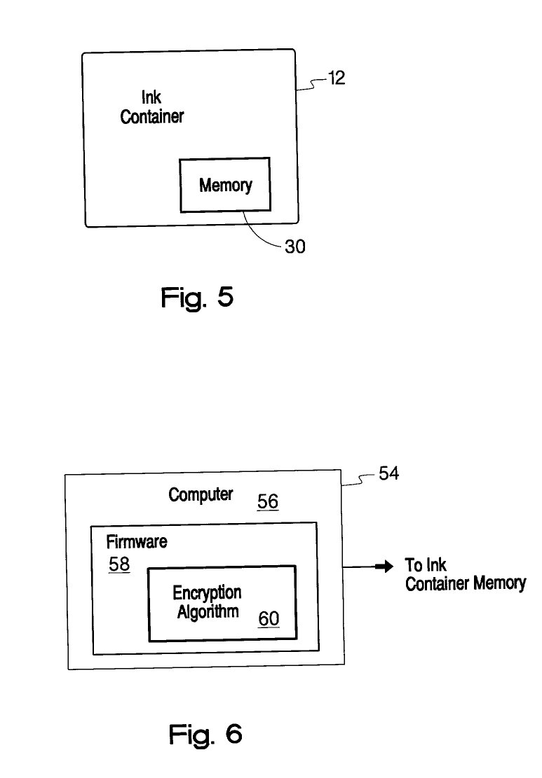

FIG. 5 is a representation of the replaceable printing component 12 of the exemplary embodiment of the present invention. The replaceable printing component 12 includes the electrical storage device 30. In the exemplary embodiment the replaceable printing component 12 is the ink container 12 for providing ink to the inkjet printing system 10 shown in FIG. 1A. The replaceable printing component 12 is alternatively an inkjet print cartridge that includes an ink container and printhead integrated into a housing. The printing component 12 can be a wide variety of printer components that are replaceable by the customer such a separately replaceable printhead 18 as shown in FIG. 1A or a replaceable toner cartridge to name a couple.

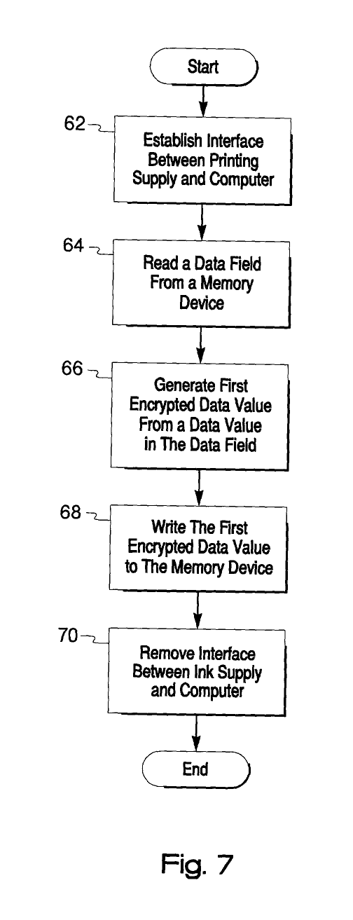

FIG. 6 depicts a simplified representation of a memory programming device 54 according to an exemplary embodiment of the present invention. The memory programming device 54 is a wide variety of devices capable of exchanging information with the memory 30 associated with the replaceable ink container 12. The memory programming device 54 can communicate with the ink container 12 in a wide variety of ways such as by a electrical connection, optical link or radio frequency (RF) link to name a few. In the exemplary embodiment, the memory programming device 54 is a computer 56. The computer 56 executes instructions or firmware 58 that is stored on an electrical storage device included in the computer 56. Included in the instructions or firmware 58 is an encryption algorithm 60. The encryption algorithm will be discussed in more detail with respect to FIG. 7.

FIG. 7 shows an exemplary method of the present invention for storing encrypted information on the memory 30 for use by the printing system 10 to authenticate the printing component or ink container 12. The printing system 10 authenticates the ink container 12 to ensure the customer is receiving maximum customer value. Ink containers 12 that cannot be authenticated require some action such as notifying the customer.

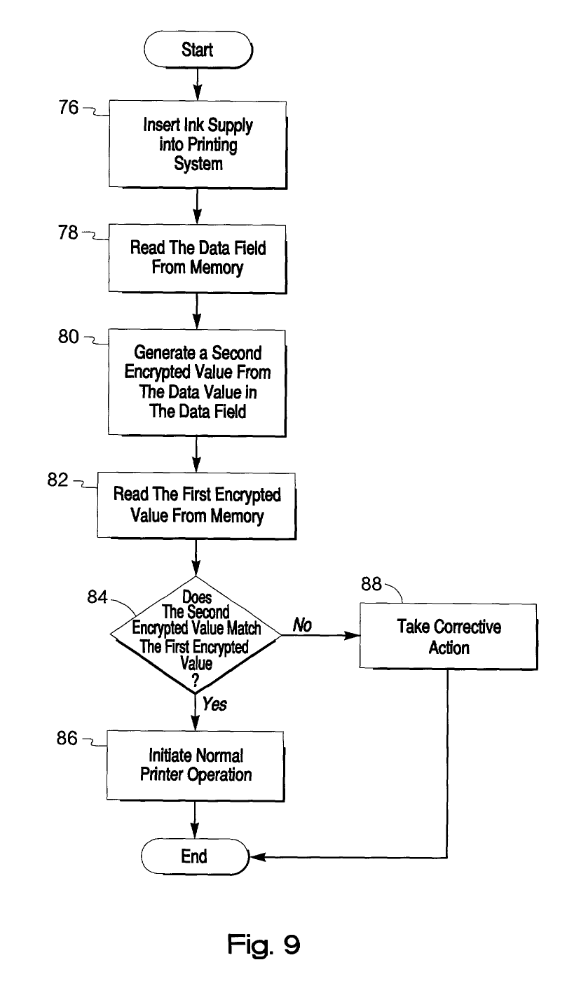

The exemplary method is initiated by establishing an electrical interface between the memory 30 and computer 54 as represented by step 62. The encryption algorithm 60 directs computer 56 to read a data field from the memory 30 as represented by step 64. A data value that is stored in the data field can be any data value or portion thereof that is stored on the memory 30. It is important that the customizer identify the particular data field because that same data field must be used by the printing system 10 as will be discussed with respect to FIG. 9. Some examples of data fields that can be selected is the serial number of the ink container 12 or the first bit of each byte of data stored in the memory 30, to name a couple.

The computer 56 generates a first encrypted data value from the data value stored in the data field as represented by step 66. In the exemplary embodiment, the first encrypted data value is generated by using the encryption algorithm 60 on the data value. The encryption algorithm can be a variety of methods or algorithms to modify the data value in a repeatable manner such as by taking the cube root of the decimal representation of the data value to the modulo of a predetermined prime number or factored prime number to generate the encrypted value.

The first encrypted data value is then stored in the memory 30 as represented by step 68. In the exemplary embodiment the first encrypted data value is stored in a write once portion of the memory 30 so that the first encrypted data value cannot be altered once stored in memory 30. In this exemplary embodiment the encryption method is performed by the computer 56 under control by the firmware 58. Alternatively, the computer 56 can be a programmable controller or a hardware implementation that provides the function of the computer 56.

The first encrypted data value is stored in the memory 30 in a predetermined location or data field in the memory 30 reserved for the encrypted data value. In an alternative embodiment, the first encrypted data value is stored in the memory 30 in a location that is based on the first encrypted data value. For example, the first encrypted data value that has more than one decimal value and with the first decimal value equal 7. The remaining encrypted decimal value is stored in memory 30 starting in byte 7. Other arrangements are also possible as long as the location is predictable knowing the first encrypted data value and the encryption method. After the first encrypted data value is stored in the memory 30 then the electrical interface established between the memory 30 and computer 56 is removed as represented by step 70.

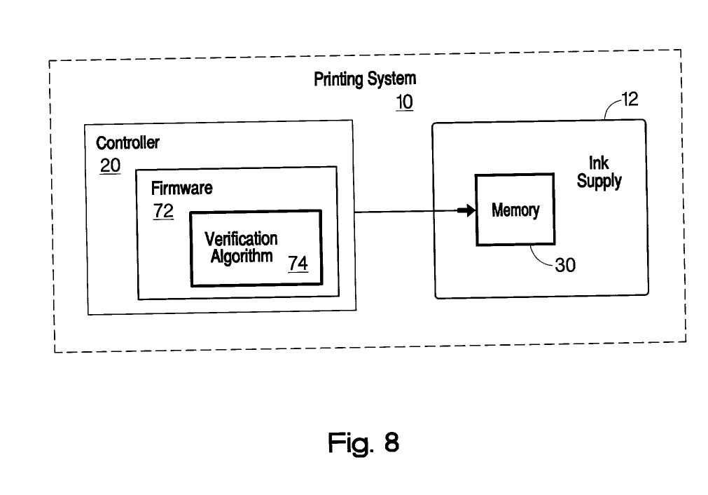

FIG. 8 is a simplified model of the printing system 10 shown in FIGS. 1A and 2 according to the exemplary embodiment of the present invention. The printing system 10 includes the controller 20. In the exemplary embodiment, the controller 20 is a processor or programmable controller that is controlled by software or firmware 72. In this exemplary embodiment a verification method embodied in a verification algorithm 74 is executed by the firmware 72 as will be discussed with respect to FIG. 9. The controller 20 is linked to the memory 30 for transferring information therebetween.

FIG. 9 shows a method of the exemplary embodiment for verifying the authenticity of the ink container or replaceable printing component 12. Once an ink container is inserted into the printing system 10 the authenticity of the ink container 12 is determined to ensure customer value. Insertion of the ink container 12 into the printing system establishes a link between the memory 30 on the ink container 12 and the controller 20, represented by step 76. The controller 20 retrieves a data value from the data field in the memory 30. The data field from which the data value is retrieved is the same data field that is used in step 64 of FIG. 7 for generating the first encrypted value. The controller 20 uses the verification algorithm 74 to generate a second encrypted data value from the data value retrieved in step 78. This second encrypted data value is generated in step 80 using the same encryption algorithm as used in step 66 of FIG. 7.

A data value from the data field that was used to store the first encrypted value in the memory 30 during step 68 of the method of FIG. 7 is then retrieved, as represented by step 82. The controller 20 then compares the second encrypted data value generated in step 80 with the data representing the first encrypted data value read in step 82. If the second encrypted data value matches the first encrypted data value then printer operation is initiated as represented by steps 84 and 86.

If the second encrypted data value does not match then the replaceable printer component or ink container 12 is not authentic. Corrective action is taken as represented by step 88. Corrective action may be a notification to the customer so that an authentic replaceable printer component or ink container 12 can be installed to ensure customer value.

What is claimed is:

1. A method for verifying authenticity of a replaceable printing component, the method comprising:
encrypting a data value stored on the replaceable printing component using a selected encryption technique to produce an encrypted value; and
comparing the encrypted value with an authentication value stored on the replaceable consumable whereby the replaceable printing component is authentic if the encrypted value is identical to the authentication value.

2. The method of claim 1 wherein the replaceable printing component is an ink supply for an inkjet printing system.

3. The method of claim 1 wherein prior to encrypting the data value stored on the replaceable printing component the steps of encrypting the data value using a selected encryption technique to produce an authentication value and storing each of the data value and the authentication value on the electrical storage device.

4. A method for storing a data value in an electrical storage device, the electrical storage device for use with a replaceable printing component, the method comprising:
encrypting the data value using a selected encryption technique to produce an authentication value; and
storing each of the data value and the authentication value on the electrical storage device.

5. The method of claim 4 wherein the replaceable printing component is an ink supply for an inkjet printing system.

6. The method of claim 4 wherein further including the steps of:
encrypting a data value stored on the replaceable printing component using a selected encryption technique to produce an encrypted value; and
comparing the encrypted value with an authentication value stored on the replaceable consumable whereby the replaceable printing component is authentic if the encrypted value is identical to the authentication value.

7. The method of claim 4 wherein the steps of encrypting the data value and storing each of the data value and the authentication value on the electrical storage device are performed by a processing device other than a printing system.

8. The method of claim 6 wherein the steps of encrypting a data value stored on the replaceable printing component and comparing the encrypted value with an authentication value stored on the replaceable consumable are performed by a printing system.

9. The method of claim 6 further including the step of notifying customers that the replaceable printing component is not authentic if the encrypted value is different from the authentication value.

10. The method of claim 6 wherein the replaceable printing component is an ink supply and further including the step of providing ink from the replaceable printing component to a printing system if the encrypted value is identical to the authentication value.

11. A method for customizing a replaceable printing component for use in only selected printing systems, the replaceable printing component having an electrical storage device for storing data in a first portion of the electrical storage device, the method comprising:
storing authentication data in a second portion of the electrical storage device, the authentication data derived from encrypting the first data using an encryption technique whereby prior to use of the replaceable printing component in the selected printing system requires resulting data from encryption of the first data using the encryption technique match the authentication data stored in the electrical storage device.

12. The method of claim 11 wherein the replaceable printing component is an ink supply and selected printing systems are inkjet printer portions.

13. A replaceable printing component for use in a selected printing system, the replaceable printing component including:
an electrical storage device configured for storing a data value and an identifier value, the identifier value is derived by encrypting the data value using an encryption process whereby upon installation of the replaceable printing component into the selected printing system the selected printing system processes the data value using the encryption process to obtain an encrypted value that is identical to the identifier value if the replaceable printing component is a verified replaceable printing component.

14. The replaceable printing component of claim 13 wherein the replaceable printing component includes a supply of ink and the selected printing system is an inkjet printing system configured to receive the supply of ink.
